(19) United States
(12) Patent Application Publication
(10) Pub. No.: US 2005/0286078 A1
(43) Pub. Date: Dec. 29, 2005

(54) Print control device and method for automatically resuming a printing operation of remaining pages

(76) Inventor: Yoshiko Maruyama, Kanagawa (JP)

Correspondence Address: DICKSTEIN SHAPIRO MORIN & OSHINSKY LLP, 2101 L Street, NW, Washington, DC, 20037, US

(21) Appl. No.: 11/151,195

(22) Filed: Jun. 14, 2005

(30) Foreign Application Priority Data
Jun. 17, 2004 (JP) NO. 2004-180194
May 30, 2005 (JP) NO. 2005-157864

(51) Int. Cl. G06F 15/00

(52) U.S. Cl. 358/1.15

(57) ABSTRACT

A print control device and a printing device, which are connected through a network, automatically resume printing from a middle of the printing if a power of the printer is turned off during printing for some reasons and after the power is turned on again. The print control device adds a bidirectional communication start command to print data to be sent to the printing device, and stores the print data which has been sent to the printing device. The print control device receives information indicating pages already printed, the information being sent from the printing device.

### BACKGROUND OF THE INVENTION

1. Field of the Invention

The present invention generally relates to a print control technique and, more particularly, to a print control device and a printing device connected through a network.

2. Description of the Related Art

Conventionally, there is known a network printing system that prints print data sent from a terminal unit through a network by the printer. As a network printing system, there is a system, such as disclosed in the following patent documents 1 and 2, in which a printer is provided with means for accumulating print data and means for managing a number of pages that have been printed so as to perform an error recovery on the printer side when an obstacle occurs in the printer. In such a system, if an obstacle such as paper jamming occurs in a printer, the printer is not turned off when eliminating the obstacle so that the printer can retain print data and a remaining printing operation can be performed automatically using the retained print data after the obstacle is eliminated.

Additionally, there is suggested a system, such as disclosed in the following patent document 3, that notifies, when an error occurs in a printer, a print requester of information regarding the occurrence of the error in accordance with page information managed in a print control device. The print requester manages print data on an individual page basis, and resumes a printing operation in the middle, that is, performs a so-called error recovery by resending data from a page of which printing has not been completed.

Patent Document 1: Japanese Laid-Open Patent Application No. 9-114618

Patent Document 2: Japanese Laid-Open Patent Application No. 2-217281

Patent Document 3: Japanese Laid-Open Patent Application No. 2000-20273

In the printing system disclosed in the patent documents 1 and 2, when an obstacle occurs in a printer, there may be a case in which a user turns off a power of the printer so as to perform an operation to eliminate the obstacle. Or, there is a case in which turning off a power is required by a work procedure when performing an operation to eliminate an obstacle in a printer. If a power is turned off in the middle of printing, the print data is not retained and is lost in the conventional printing system. In such as case, the printing cannot be resumed from the middle of printing if a power of the printer is turned on after the obstacle is eliminated since the print data of which printing is stopped in the middle is lost. Thus, there is a problem in that automatic recovery cannot be achieved.

Although there is no need to provide storing means for retaining print data in a printer in the printing system disclosed in the patent document 3, it is necessary for a print requester (terminal device) to manage the print data on an individual page basis. Moreover, the print requester (terminal device) must produce data corresponding to pages of which printing has not been completed and send again to the print requester.

Moreover, if there exit a plurality of print requesters (terminal devices) in the network, there is a possibility that a print instruction is made by other print requesters (terminal devices) before the instruction of the remaining pages is made.

### SUMMARY OF THE INVENTION

It is an object of the present invention to provide an improved and useful print control device and printing device in which the above-mentioned problems are eliminated.

A more specific object of the present invention is to provide a print control device and a printing device which can automatically resume printing from a middle of the printing if a power of the printer is turned off during printing for some reasons and after the power is turned on again in a network system in which the printer and a terminal device is connected through a network.

In order to achieve the above-mentioned objects, there is provided according to one aspect of the present invention a print control device that controls an operation of a printing device, comprising; a bidirectional communication start command adding part that adds a bidirectional communication start command to print data; a print data storing part that stores the print data which has been sent to the printing device; and a page information receiving part that receives information indicating pages already printed, the information being sent from the printing device.

The print control device according to the above-mentioned invention may further comprise a print start page adding part that adds page information to the print data, the page information indicating a page to start printing. Additionally, the print control device may further comprise an equipment monitoring part that monitors a shut-off of a power of the printing device, and wherein, when a communication with the printing device is reestablished after a shut-off of the power of the printing device is detected, the page information is added to the print data and is resent to the printing device. The print control device may further comprise a copy number information updating part that produces copy number information regarding a number of copies to print, wherein the print start page adding part adds the page information and the copy number information to the print data. The print control device may further comprise an equipment monitoring part that monitors a shut-off of a power of the printing device, and wherein, when a communication with the printing device is reestablished after a shut-off of the power of the printing device is detected, the page information and the copy number information is added to the print data and is resent to the printing device.

Additionally, there is provided according to another aspect of the present invention a printing device that performs printing based on received print data, the printing device starts printing based on page information contained in the received print data, the page information indicating a page to start the printing.

In the printing device according to the present invention, printing of pages before the page to start the printing is not performed so as to start the printing from the page to start the printing. In the printing device according to the present invention, the printing is started based on copy number information contained in the received print data, the copy number information indicating a number of copies to print.

Additionally, there is provided according to another aspect of the present invention a network system comprising: the above-mentioned print control device; and the above-mentioned printing device, wherein the print control device and the printing device are connected through a network.

Further, there is provided according to another aspect of the present invention a print control method of a printing device that performs printing based on received print data, the print control method comprising: adding a bidirectional communication start command to the print data and sending the print data to the printing device; sending a page completion notification from the printing device each time printing of one page is completed; adding page information indicating a page to start printing to the print data and resending the print data to the printing device when a power of the printing device is turned on after the power of the printing device is shut off in a middle of printing; and performing remaining printing based on the page information.

In the print control method according to the present invention, the step of resending may add information indicating a number of remaining copies.

Additionally, there is provided according to another aspect of the present invention a print control program causing a computer to perform the above-mentioned print control method, and a computer-readable recording medium storing the print control program.

According to the present invention, even if a power of the printing device is turned off in the middle of printing and the power of the printer is turned on again, the print data is sent automatically from the print control device. In addition, since the information regarding a page to start printing is added to the resent print data, printing of the remaining pages can be resumed automatically.

Additionally, when the information regarding the number of copies to start printing and the page start printing is added to the resent print data, printing of only the remaining pages and remaining copies can be resumed automatically.

Other objects, features and advantages of the present invention will become apparent from the following detailed description when read in conjunction with the accompanying drawings.

### BRIEF DESCRIPTION OF THE DRAWINGS

FIG. 1 is an illustration showing a structure of a network printing system according to an embodiment of the present invention;

FIG. 2 is a block diagram showing a part of a function of a client PC;

FIG. 3 is a block diagram of a function of a port monitor provided in the client PC according to a first embodiment of the present invention;

FIG. 4 is a block diagram of a function of a main control part provided in a printer according to the first embodiment of the present invention;

FIG. 5 is a flowchart showing an operation of a print control method which the client PC according to the first operation of the present invention performs;

FIG. 6 is a sequence diagram of an example of a printing recovery operation performed in the printing system according to the first embodiment of the present invention;

FIG. 7 is an illustration showing a structure of print data;

FIG. 8 is an illustration showing the contents of the print data to which a bidirectional communication start command is added;

FIG. 9 is an illustration showing the contents of the print data to which a start page designation command is added.

FIG. 10 is a block diagram of a port monitor provided in a client PC according to a second embodiment of the present invention;

FIG. 11 is a block diagram of a function of a printer according the second embodiment of the present invention;

FIG. 12 is an illustration showing the contents of an example of print data that is resent when printing a plurality of copies;

FIG. 13 is an illustration showing another example of the print data that is resent when printing a plurality of copies;

FIG. 14 is a flowchart showing a job progress situation analysis operation in a client PC according to the second embodiment of the present invention; and

FIG. 15 is a sequence diagram of an example of a printing recovery operation performed in a printing system according to the second embodiment of the present invention.

### DETAILED DESCRIPTION OF THE PREFERRED EMBODIMENTS

A description will now be given, with reference to the drawings, of embodiments of the present invention.

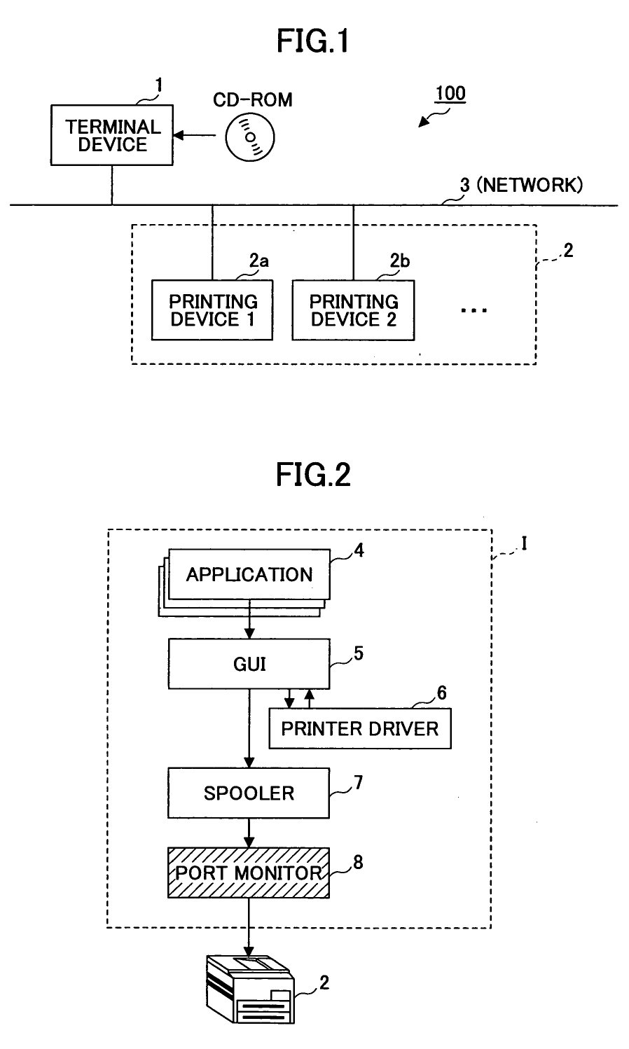

FIG. 1 is an illustration showing a structure of a network printing system according to a first embodiment of the present invention. The network printing system 100 comprises a terminal device 1, a plurality of printing devices 2a and 2b, (hereinafter generally referred to as a printing device 2), and a network 3 that connects these devices. The terminal device 1 is a personal computer (PC), a server device, or the like that issues a print request to the printing device 2 and sends print data to the printing device 2. Additionally, the terminal device 1 can also control a printing process performed by the printing device 2 so as to serve as a print control device. Hereafter, the terminal device 1 is referred to as a client PC 1.

The printing device 2 is a printer, a copy machine or a facsimile machine having a printing function, or the like that is connected to the client PC 1 through the network 3. The printing device 2 receives the print request issued by the client PC 1, and prints the print data sent from the client PC 1.

FIG. 2 is a block diagram showing a part of the function of the client PC 1. The client PC 1 has an application 4 as software. The application 4 causes a printer driver 6 to produce print data through a graphical user interface (GUI) 5 when performing a printing process. The produced print data is sent to the spooler 7 through the GUI 5, and is stored temporarily therein. The spooler 7 is a print module that manages print jobs. It should be noted that the application 4, the GUI 5 and the spooler 7 are software that operates on an operation system (OS) such as, for example, Windows (registered trademark).

The client PC 1 is connected to the network 3 through the port monitor 8, and is connected to the printing device 2 through the network 3. Therefore, the print data stored in the spooler 7 is sent to a port monitor 8, and is sent out to the network 3 from the port monitor 8.

A description will be given below of embodiments of the present invention in detail.

### First Embodiment

In the first embodiment of the present invention, if a power of the printing device 2 is turned off in the middle of printing of a document including a plurality of pages and is turned on again, printing of the remaining pages is started automatically.

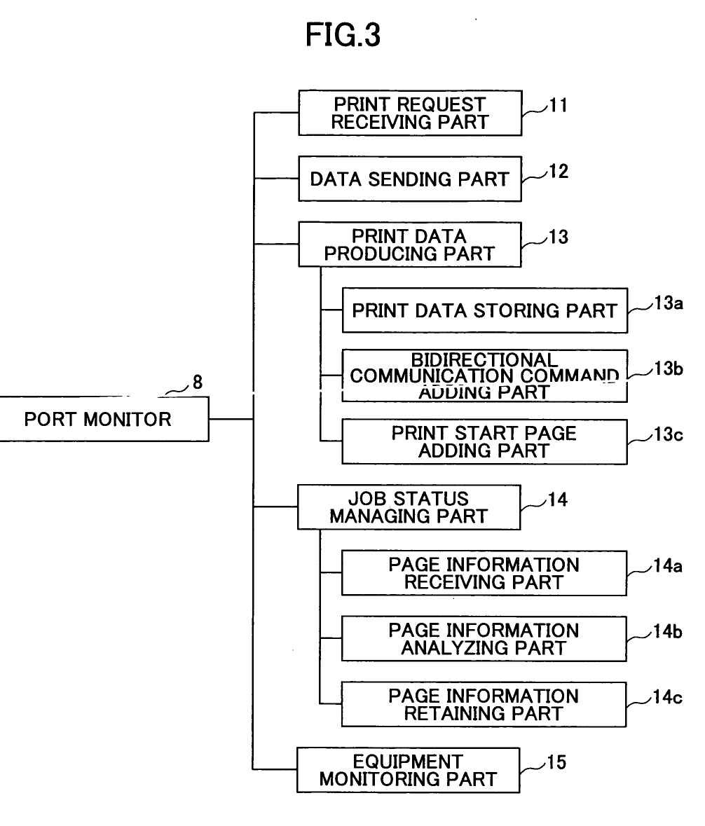

FIG. 3 is a block diagram of the function of the port monitor 8 provided in the client PC 1 according to the first embodiment.

The port monitor 8 comprises: a print request receiving part 11 which receives a print request from applications such as a word processor; a data transmitting part 12 which transmits the print data, a print-data producing part 13 which stores processes the print data; a job status managing part 14 which manages progress of a job from the printing device 2; and an equipment monitoring part 15 which monitors the status of operation of the printing device 2.

The print-data producing part 13 includes: a print-data storing part 13a which stores the print data which has been transmitted to the printing device 2; a command adding part 13b which adds a bidirectional communication start command to the print data; and a page adding part 13c which adds information regarding a printing start page to the print data.

The job status managing part 14 includes: a page information receiving part 14a which receives a page eject completion notification (page information); a page information analyzing part 14b which analyzes the received page information: and a page information retaining part 14c which stores the page information (job progress information) based on a result of the analysis.

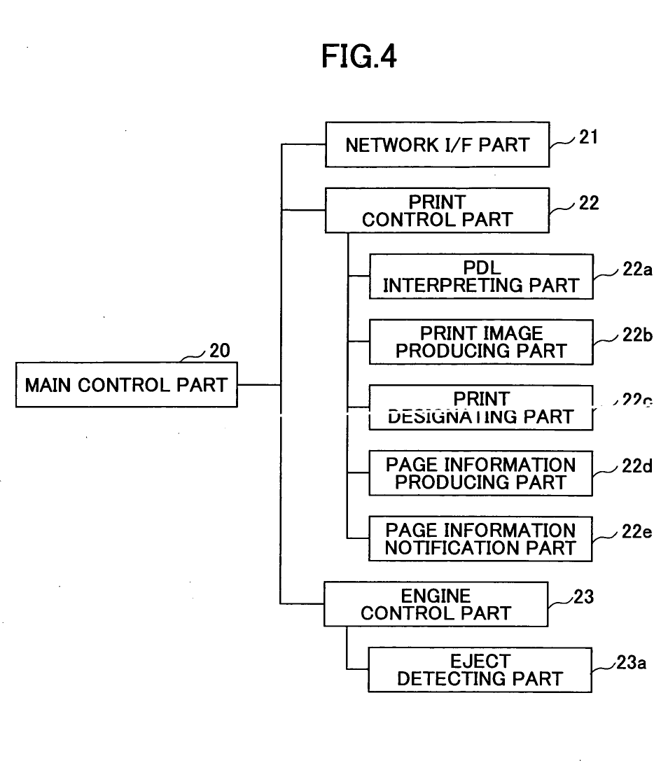

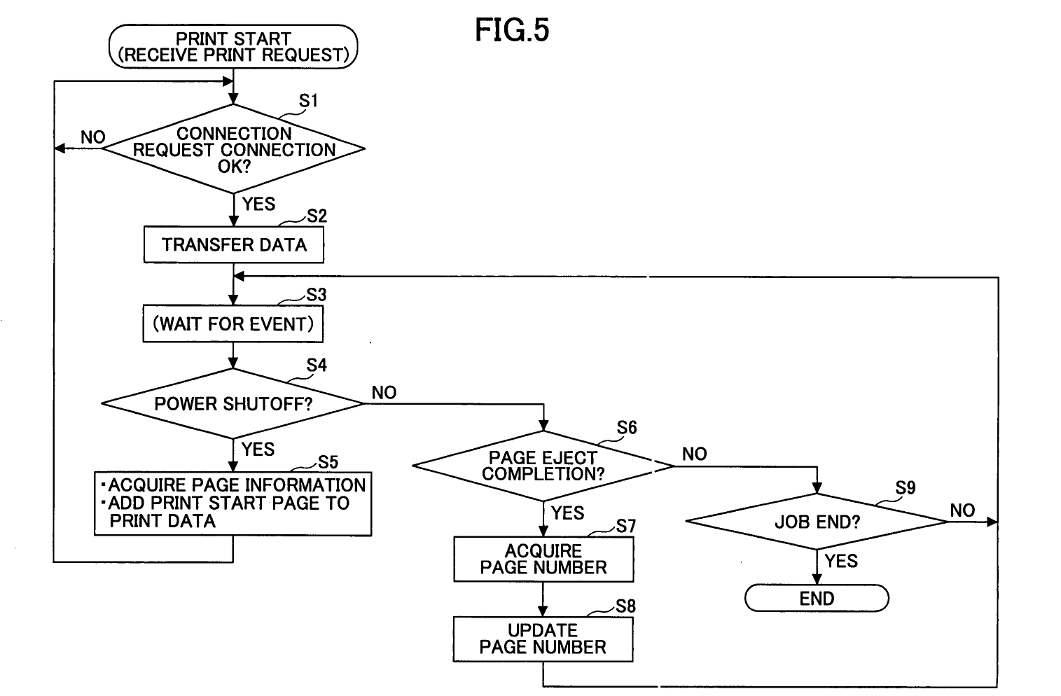

FIG. 4 is a block diagram of a function of a main control part 20 provided in the printing device 2 according to the first embodiment. The main control part 20 comprises: a network I/F part 21 which manages an interface with the network 3; a print control part 22 which controls printing; and an engine control part 23 which performs a control of an engine. The print control part 22 includes: a PDL interpreting part 22a which interprets the print data (PJL/PDL) received; a print image producing part 22b which develops the print data to an image based on a result of the interpretation; a print instruction part 22c which sends a print instruction to the engine control part 23 when a print image corresponding to one page is produced; a page information producing part 22d which produces page eject completion information (page information) to be sent to the client PC 1 when a paper ejection is detected by the engine control part 23; and a page information notification part 22e which notifies the produced page information.

FIG. 5 is a flowchart showing an operation of a print control method which the client PC 1 according to the first embodiment performs. When a print request from the application 4 such as a word processor in the client PC 1 is received by the print request receiving part 11, the data transmitting part 12 makes a connection request for transmitting print data to the printing device 2, and it is determined whether or not a connection permission is obtained (step S1). If the printing device 2 permits the connection with respect to the connection request (Yes of step S1), the data transmitting part 12 adds a bidirectional communication start command to the print data from the spooler 7 by the command adding part 13b, and sends the print data to the printing device 2 (step S2). At this time, the page information in the page information retaining part 14c is initialized and is set to zero. Thereafter, an event waiting state is set to wait for a following event (step S3). At this time, a bidirectional communication between the printing device 2 and the client PC 1 is achieved based on the bidirectional communication start command added to the print data.

Then, it is determined whether or not a power of the printing device 2 is turned off in an event waiting state. Here, whether or not the power of the printing device 2 is turned off is determined by detecting whether or not the communication with the printing device 2 is interrupted. That is, if the power of the printing device 2 is turned off or shut off, the communication between the client PC 1 and the printing device 2 is interrupted.

If it is determined in step S4 that a power is turned off (Yes of step S4), the print start page information is added to the print data by the print start page adding part 13c based on the page information retained by the page information retaining part 14c of the job status managing part 14 (step S5). Thereafter, the routine returns to step S1 so as to make a connection request and determine whether or not a connection permission is obtained. The process of step S1 is repeatedly performed for each fixed time until the connection permission is obtained.

On the other hand, if it is determined in step S4 that the power is not turned off (No of step S4), it is determined whether or not a page eject completion notification is received from the printing device 2 (step S6). If the page eject completion notification is received (Yes of step S6), the page eject completion notification (page information) is analyzed by the page information analyzing part 14b, and a number of pages of which ejection is completed in the printing device 2 is acquired (step S7). Then, the acquired number of pages is retained as a new number of pages by the page information retaining part 14c (step S8), and the routine returns to step S3.

If it is determined in step S6 tat the page eject completion notification is not received (No of step S6), it is determined whether or not the job is ended (step S9). If it is determined that the job is ended (Yes of step S9), the process at this time is ended. If the job is not ended, the routine returns to step S3. It should be noted that, in the above-mentioned process, the number of pages may be retained by using a page counter. That is, when sending the print data for the first time (step S2 of FIG. 5), the page counter is initialized and the count value of the page counter is incremented each time the page eject completion notification is received from the printing device 2 (step S8 of FIG. 5). Thereby, the count value of the page counter can be used as the number of pages of which printing has been completed.

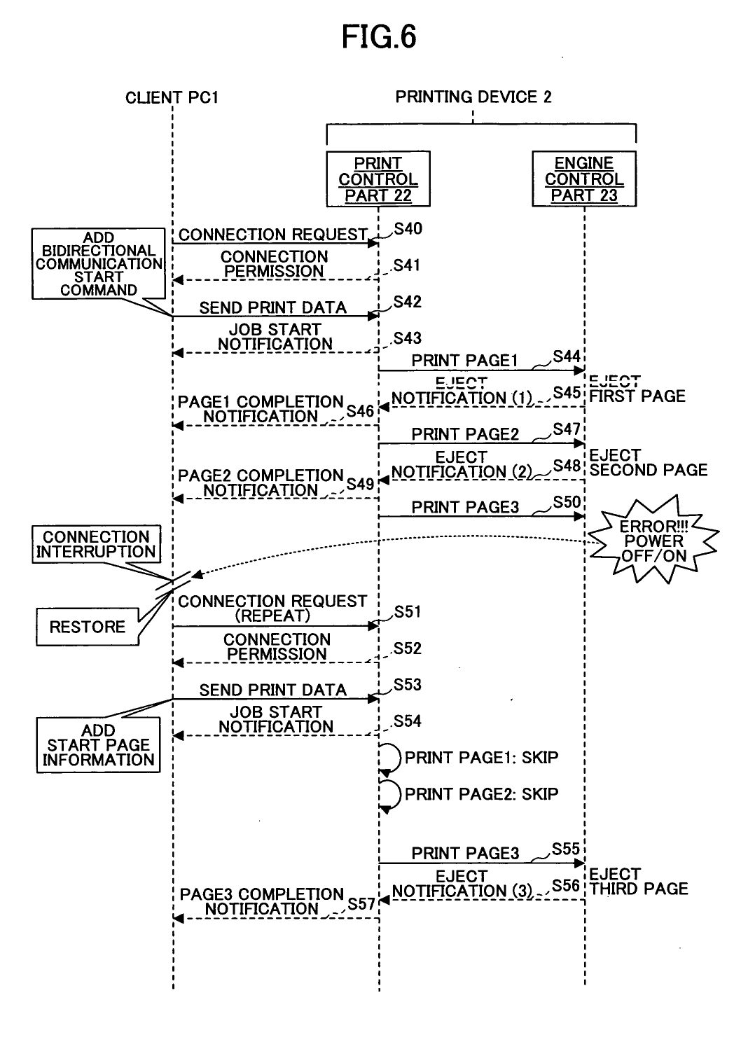

FIG. 6 is a sequence diagram of an example of a print recovery operation performed in the printing system according to the first embodiment. In this example, it is assumed that, when performing printing of a document including 3 pages, an error occurs at a time when eject of the second page is completed and, thereafter, a power of the printing device 2 is turned off. It should be noted that FIG. 6 is a sequence diagram of operations between the port monitor 8 of the client PC 1, the print control part 22 of the printing device 2 and the engine control part 23.

First, a connection request is sent from the port monitor 8 of the client PC 1 to the print control part 22 of the printing device 2 (step S40). In response to the connection request, a connection permission is sent to the client PC 1 from the print control part 22 (step S41). Upon reception of the connection permission, the client PC 1 sends print data to the printing device 2 through the port monitor 8 (step S42). Here, a bidirectional communication start command is added to the print data sent to the printing device 2 by command adding part 13b. Thereby, the printing device 2 sets up a bidirectional communication with the client PC 1. Then, the print control part 22 of the printing device 2, which received the print data, sends a job start notification to the client PC 1 (step S43).

Then, a print start instruction for the first page is sent from the print control part 22 to the engine control part 23 (step S44). After the first page is printed and ejected, an eject notification indicating completion of the first page is sent from the engine control part 23 to the print control part 22 (step S45). Thereby, the print control part 22 sends a Page1completion notification to the port monitor 8 of the client PC 1 (step S46).

Similarly, a print start instruction for the second page is sent from the print control part 22 to the engine control part 23 (step S47). After the second page is printed and ejected, an eject notification indicating completion of the second page is sent from the engine control part 23 to the print control part 22 (step S48). Thereby, the print control part 22 sends a Page2 completion notification to the port monitor 8 of the client PC 1 (step S49).

At this stage, an error occurs after the completion of eject of the second page, and a power of the printing device 2 is turned off. Consequently, the communication with the printing device 2 is interrupted, and the client PC 1 judges that the power of the printing device 2 has been turned off or shut off. Upon detection of the shut-off, the client PC 1 makes a connection request again (step S51). This connection request is repeatedly performed each fixed time until a connection permission is sent from the printing device 2. That is, the connection request is continuously sent until the power of the printing device 2 is turned on and the communication with the client PC is permitted and the connection permission is sent so that the communication between the client PC 1 and the printing device is reestablished.

When the power of the printing device 2 is turned on again and the connection permission is sent (step S52), the port monitor 8 of the client PC 1 adds a page number as start page information, which is acquired by adding 1 to the number of pages that have been completed, to the print data (the same as the print data initially sent to the printing device 2) retained by the print data retaining part 13a, and sends the print data to the printing device 2 (step S53). The printing device 2 sends a job start notification to the client PC 1 (step S54). Then, if the print start designation page number is contained in the received print data which received, the printing device 2 does not perform the printing process of the data corresponding to the pages before the start designation page number and start printing from the start designation page number. In this example, “3” is contained in the print data as a start designation page number, and, thus, the printing control part 22 of the printing device 2 sends an instruction to the engine control part 23 to skip the first and second pages without performing the printing and perform printing of the third page. Then, after the printing of the third page is completed and the third page is ejected, the engine control part 23 sends an eject notification to the print control part 22 (step S56). Then, the print control part 22 sends a Page3 completion notification to the client PC 1 (step S57).

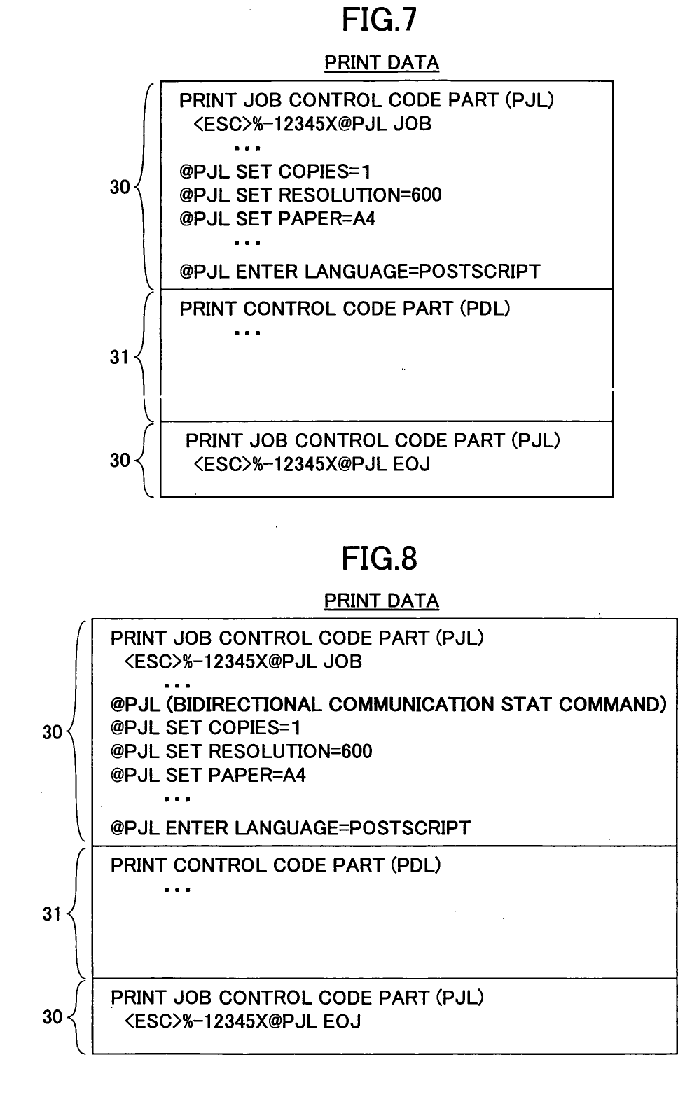

By the way, the print data sent to the port monitor 8 from the spooler 7 has a structure such as shown in FIG. 7. That is, the print data contains a print job control code 30 that is described by PJL (printer job language) and a print control code 31 described by PDL (page description language). Since the print control code 31 depends on equipments in many cases, an analysis to detect a brake point between the pages is complicated if the print control code 31 is used. On the other hand, since the print job control code 30 is described by a specification common to many printers, the print start page number can be designated by merely inserting a command, which designates a print start page, between a PJL start command in the print job control code 31 and the print control code 31.

FIG. 8 is an illustration showing the print data sent to the printing device in the above-mentioned step S42. As indicated by bold letters in the print job control code 30, the bidirectional communication start command “@PJL (bidirectional communication start command)” is described. This command is added to the print data by the bidirectional communication command adding part 13b of the port monitor 8 h shown in FIG. 3.

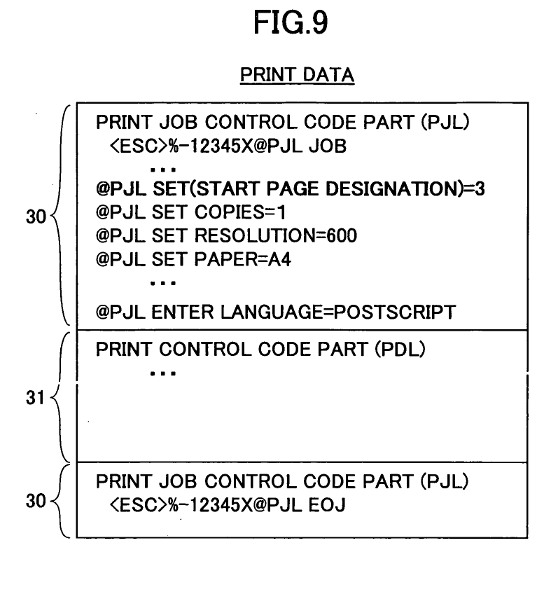

FIG. 9 is an illustration of the print data sent to the printing device 2 in the above-mentioned step S53. A command “@PJL SET (print start page)=3” is added to the print job control code 30. This command is added by the print start page adding part 13c of the port monitor 8 shown in FIG. 3. The print control part 22 of the printing device 2 can recognize in accordance with this command that printing be started from the third page. Here, the print control code 31 in which the actual print data is stored is the same as the print data transmitted initially, and contains data corresponding to all pages. Therefore, if printing is performed based on the print control code 31, the first and second pages are printed again. Then, the print control part 22 of the printing device 2 sends an instruction to the engine control part 23 to skip the first and second pages by not performing printing and perform printing from the third page in accordance with the command “(print start page)=3” contained in the print job control code 30.

Thus, by adding the command to the printer job control code 30 that is common to many printers so as to resend the print control code 32 without-any changes, printing of the remaining pages can be resumed without installing complicated software in the printing device 2.

As mentioned above, according to the present embodiment, even if a power of a printer is turned off in the middle of printing and a power of the printer is turned on again, the print data is automatically sent again from the client PC 1, which serves as a print control device. In addition, since the information regarding the print start page is added to the resent print data, printing of only the remaining pages, which were not printed, can be resumed automatically.

### Second Embodiment

In a second embodiment of the present invention, if a power of the printing device is turned off and turned on again in the middle of printing a document containing a plurality of pages, printing of the remaining pages is automatically started.

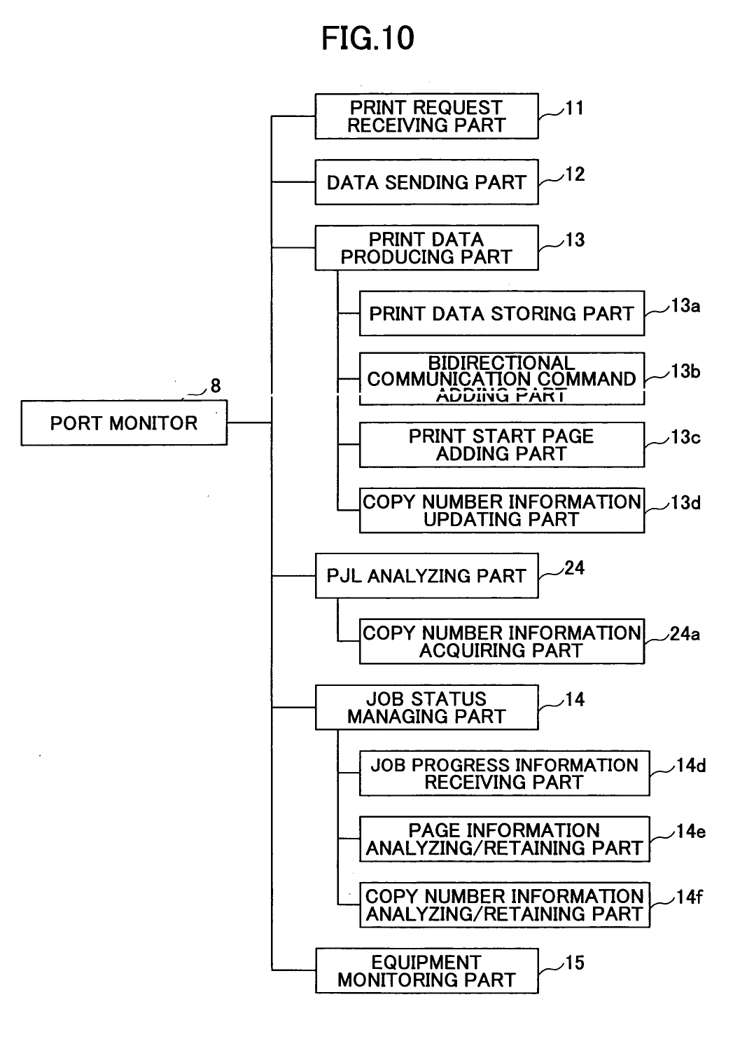

FIG. 10 is a block diagram of a function of the port monitor 8 provided in the client PC 1 according to the second embodiment. Although the port monitor 8 shown in FIG. 10 has basically the same structure as the port monitor 8 shown in FIG. 3, they differ from each other in the following points. The print-data producing part 13 further comprises a copy number information updating part 13d for producing copy number information to be added when resending the print data. The job status managing part 14 comprises a job progress information receiving part 14d, a page information analyzing/retaining part 14e and a copy number information analyzing/retaining part 14f instead of the page information receiving part 14a, the page information analyzing part 14b and the page information retaining part 14c. Moreover, the port monitor 8 shown in FIG. 8 further comprises a PJL analyzing part 24 for analyzing a number of copies designated initially by the print application. The PJL analyzing part 24 includes a copy number information acquiring part 24a which acquires copy number information from print data.

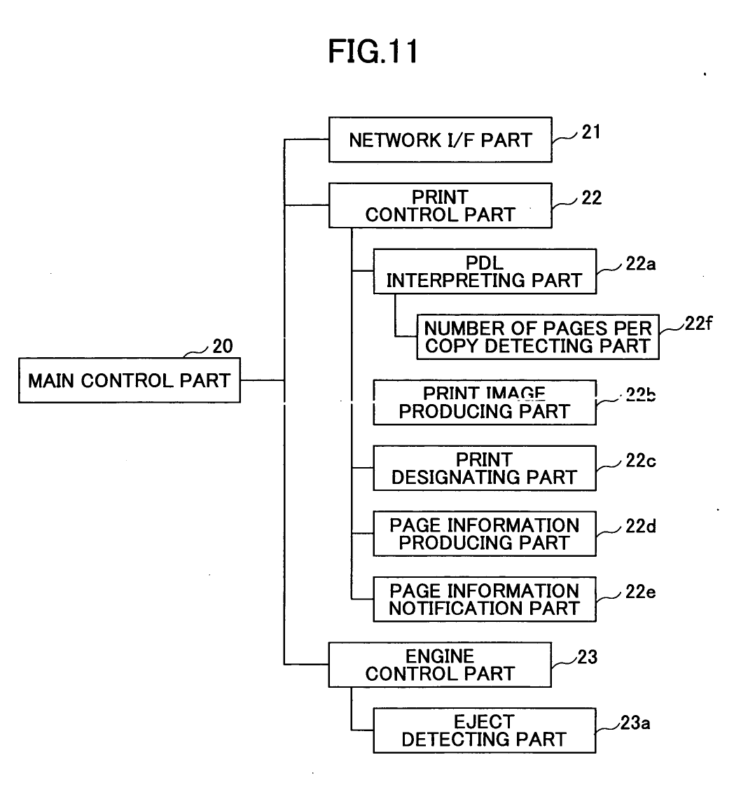

FIG. 11 is a block diagram of a function of the printing device 22 according to the second embodiment. A difference between the printing device 2 shown in FIG. 11 and the printing device 2 shown in FIG. 4 is in that the PDL interpreting part 22a of the printing device 2 shown in FIG. 11 has a page number per copy detecting part 22 which detects a number of pages contained in one copy. The page number per copy detecting part 22f detects a number of pages per one copy so as to produce page eject completion information according to which the client PC 1 can detect a number of copies to be printed.

In the case of printing a plurality of copies, a notification such as the following page information, for example, is sent from the printing device 2 to the client PC 1 each time one of the pages is ejected. Namely, the page information changes as Page1, Page2, Page3, Page1 (*1), Page2 . . . . In the case of printing a plurality of copies, the client PC 1 can detect, when the Page1 is notified second time (according to the above-mentioned *1), that the number of pages before that time is a number of pages per one copy. After the number of pages per one copy is detected, it is checked whether the number of pages per one copy is reached each time the page eject completion notification is received. Thereby, the job progress information regarding the number of pages and the number of copies of which ejection is completed can be updated.

It is assumed that an error occurs and a power is turned off after the second page of the third copy is ejected during printing of five copies of a document containing three pages. In this case, the remaining printing is started from the third page of the third copy, and, thus, data indicating “printing one copy from a start page=3 and two copies from a start page=1” is added to the job control code 30 as information for resuming the printing.

The following methods are considered to designate a copy number and a page number to start printing.

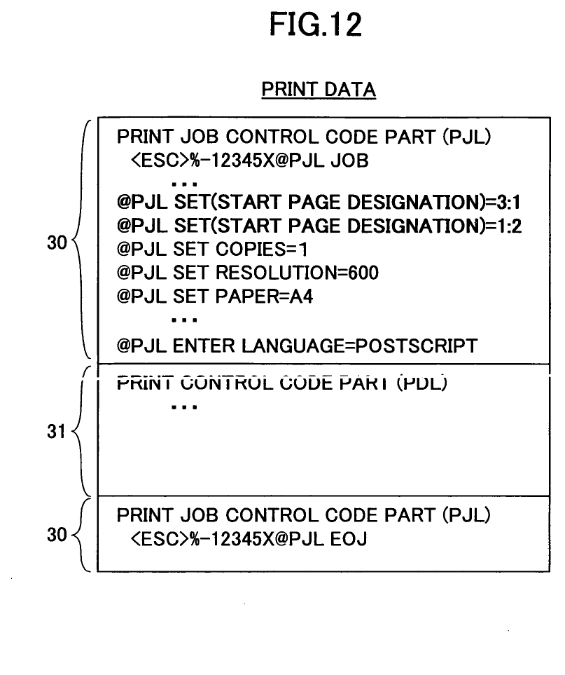

For example, as shown in the FIG. 12, data designating the page number and the copy number for starting printing and data designating remaining copies are added to the print job control code 30. In FIG. 12, CFJL SET (start page designation)=3:1” designates printing one copy starting from the third page and “@PJL SET (start page designation)=1:2” designates printing two copies starting from the first page.

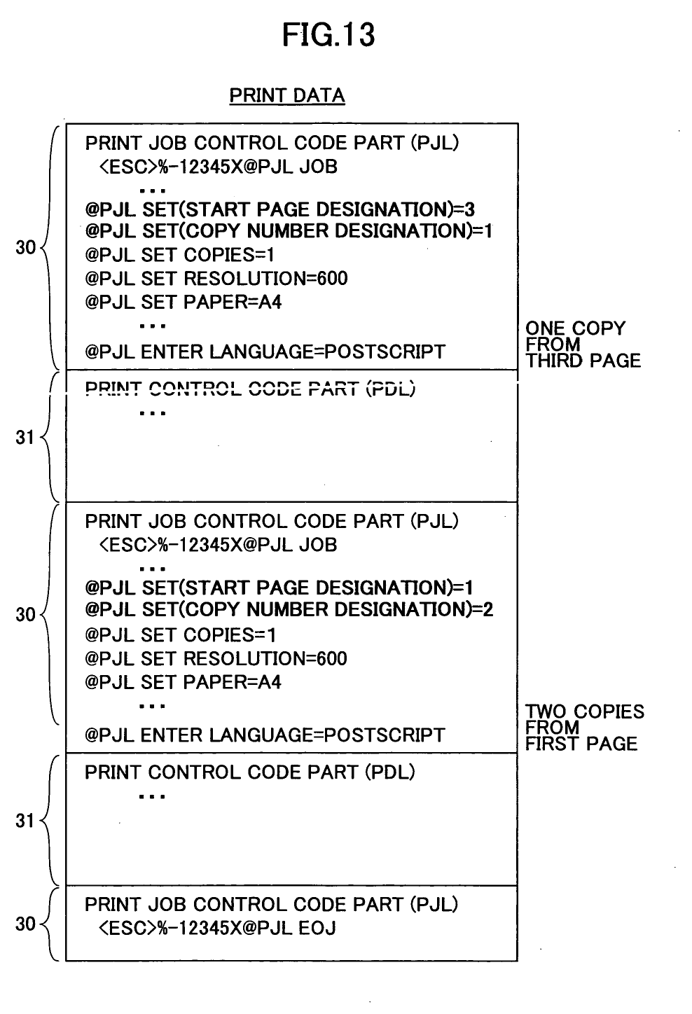

Moreover, as shown in FIG. 13, printing can also be designated by dividing it into two times. In the first print data, “@PJL SET (start page designation)=3, @PJL SET (copy number designation)=1” designates to start printing only one copy starting from the third page. Therefore, based on the designation, printing is performed using the following print code data. In this case, the first and second pages are skipped and printing of one copy is performed from the third page.

Moreover, as shown in FIG. 13, printing can also designated by dividing it into two times. In the first print data, “@PJL SET=(start page designation)=3, @PJL SET (copy number designation)=1” designates to start printing only one copy stating from the third page. Therefore, based on this designation, printing is performed using the following print code data. In this case, the first and second pages are skipped and printing of one copy is performed from the third page.

In the example shown in FIG. 13, there is provided a second print job control code 30 following the first print control code 30. “@PJL SET (start page designation)=1, @PJL SET (number of copies to print designation)=2” is added to the second print job control code 30. Therefore, printing two copies starting from the first page is designated. Based on the designation, printing for the remaining two copies is performed using the print control code 31 following the second print job control code 30.

When designating at once as in the example shown in FIG. 12, the size of the print data is about one half of that of the case where designation is made two times such as the example shown in FIG. 13, but a process in the printing device may be somewhat complicated. On the other hand, in the case of designating by dividing into two times, although the size of print data is increased, the process in the printing device is simple since the function the same as the first embodiment and the process of a plurality of copies are simply combined.

It should be noted that the present invention is not limited to the above-mentioned examples, and an arbitrary designation method may be used if page information and copy number information from which a printing start position is acquired can be added.

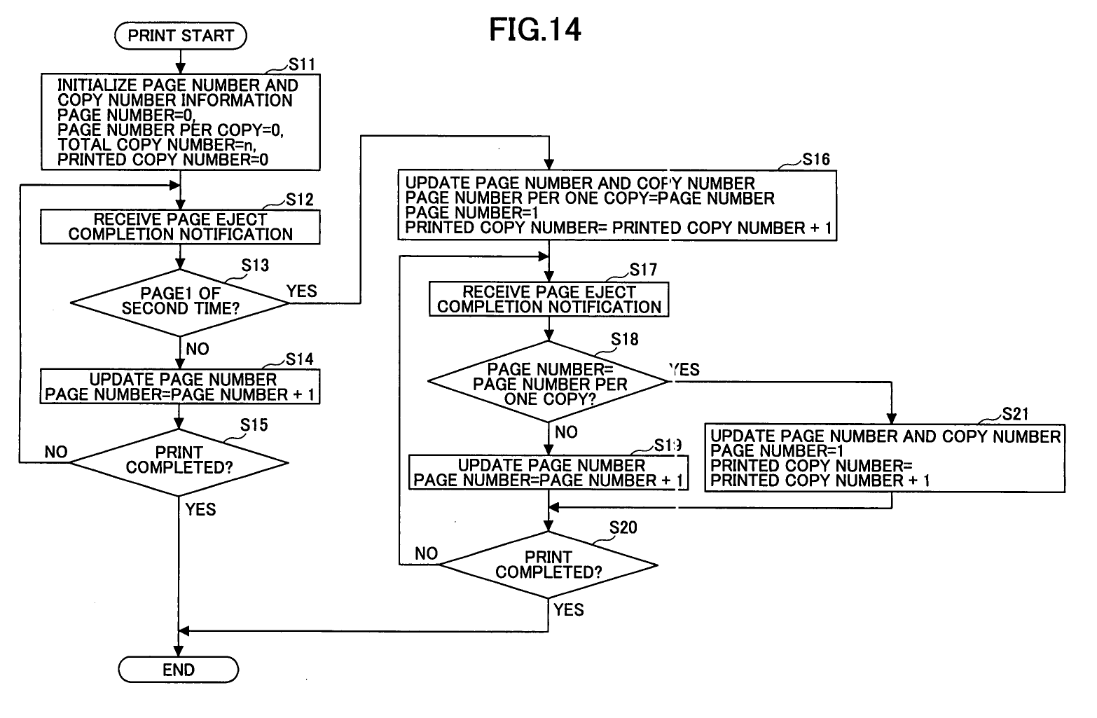

FIG. 14 is a flowchart showing a job progress analyzing operation in the client PC 1 according to the second embodiment. When printing is started, in order to initialize the page number and copy number information, page number=0, page number per one copy=0, a total copy number=n and number of printed copies=0 are set (step S11). Then, upon receipt of the page eject completion notification from the printing device 2 (step S12), it is determined whether or not the received page eject completion notification indicates the second Page1 (step S13). If the received page eject completion notification is not the second Page1 (No of step S13), the page number is updated by incrementing the page number (step S14). Then, it is determined whether or not the printing is completed (step S15). If the printing is completed (Yes of step S15), the routine at this time is ended. If the printing is not completed (No of step S15), the routine returns to step S12.

On the other hand, if it is determined in step S13 that the notification is the second Page1, the page number per one copy=page number and page number=1 are set, and the page number and the copy number are updated by incrementing the number of copies already printed (step S16). Then, upon receipt of the page eject completion notification (step S17), it is determined whether or not the page number=page number per one copy (step S18). If the number of pages is not equal to the number of pages per one copy (No of step S18), the page number is updated by incrementing the page number (step S19). Then, it is determined whether or not the printing is completed (step S20). If the printing is completed (Yes of step S20), the routine at this time is ended. If the printing is not ended (No of step S20), the routine returns to step S17.

On the other hand, if it is determined in step S18 that the page number is equal to the page number per one copy (Yes of step S18), the page number=1 is set, and the page number and the copy number are updated by incrementing the number of copies already printed, and, thereafter, the routine proceeds to step S20.

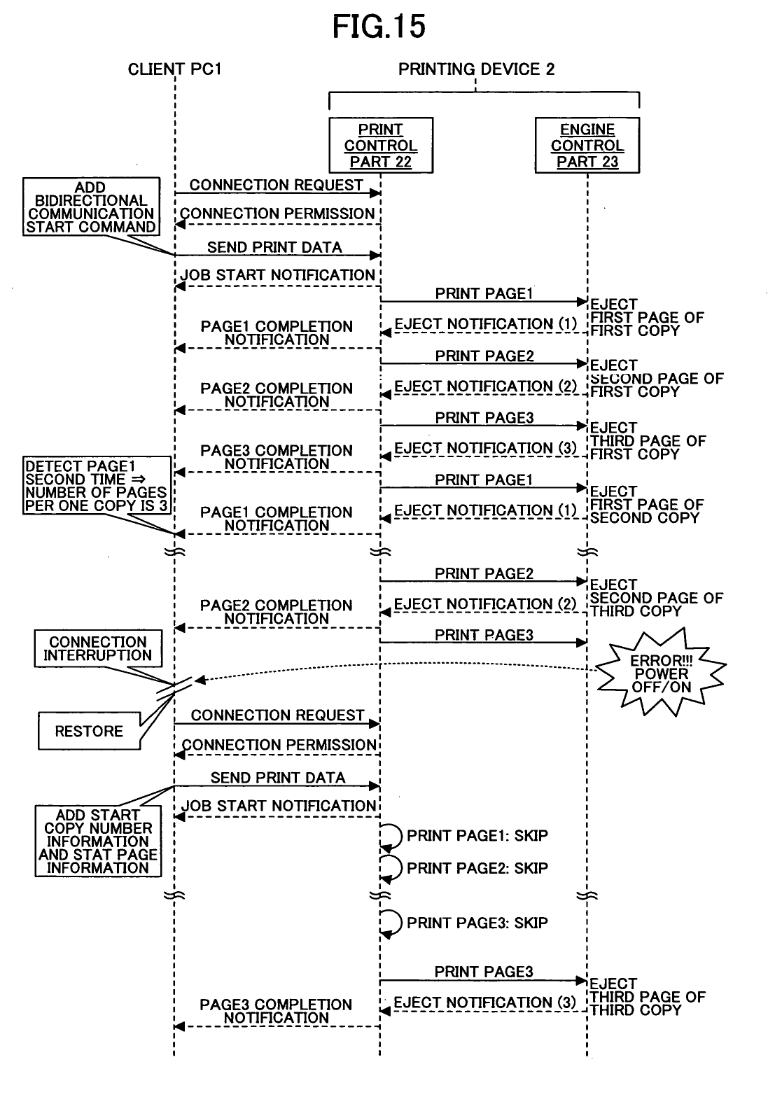

FIG. 15 is a sequence diagram of an example of a print recovery operation performed in the printing system according to the second embodiment. The sequence shown in FIG. 15 are operations of exchanging commands and data between the port monitor 8 of the client PC 1 and the print control part 22 and the engine control part 23 of the printing device 2. It should be noted that the sequence shown in FIG. 15 is similar to the sequence shown in FIG. 6, and since the sequence shown in FIG. 15 is apparent from the description of the sequence shown in FIG. 6, detailed descriptions of each step shown in FIG. 15 are omitted.

In the example shown in FIG. 15, when printing three copies of a document containing three pages, an error occurs at the time when eject of the second page of the third copy is completed and a power of the printing device 2 is turned off. When a power of the printing device 2 is returned, the communication between the client PC 1 and the printing device 2 is automatically resumed. Then, the client PC 1 sends the print data for printing the remaining pages (in this case, the third page of the third copy) to the printing device 2. It should be noted that the bidirectional communication start command is added also to the print data sent at this time so that the bidirectional communication between the client PC 1 and the printing device 2 is started. Based on the command which designates the remaining pages added to the print data, the printing device 2 prints only the remaining pages and sends a completion notification to the client PC 1.

As mentioned above, according to the present embodiment, even if a power of the printer is turned off in the middle of printing and the power of the printer is turned on again, the print data is sent automatically from the client PC 1, which serves as a print control device. In addition, since the information regarding the number of copies to start and the printing start page is added to the resent print data, printing of the remaining pages and copies can be resumed automatically.

It should be noted that the above-mentioned print control method may be described as a print control program, and can be performed by the client PC, which serves as a print control device. Additionally, such a print control program may be stored in a computer-readable recording medium such as a CD-ROM as shown in FIG. 1, and the print control program can be performed by the client PC, which serves as a print control device, reading the recording medium.

The present invention is not limited to the specifically disclosed embodiments, and variations and modifications may be made without departing from the scope of the present invention.

The present invention is based on Japanese priority applications No. 2004-180194 filed Jun. 17, 2004 and No. 2005-157864 filed May 30, 2005, the entire contents of which are hereby incorporated herein by reference.

1. A print control device that controls an operation of a printing device, comprising;
a bidirectional communication start command adding part that adds a bidirectional communication start command to print data;
a print data storing part that stores the print data which has been sent to said printing device; and
a page information receiving part that receives information indicating pages already printed, the information being sent from said printing device.

2. The print control device as claimed in claim 1, further comprising a print start page adding part that adds page information to the print data, the page information indicating a page to start printing.

3. The print control device as claimed in claim 2, further comprising an equipment monitoring part that monitors a shut-off of a power of said printing device, and wherein, when a communication with said printing device is reestablished after a shut-off of the power of said printing device is detected, said page information is added to the print data and is resent to said printing device.

4. The print control device as claimed in claim 2, further comprising a copy number information updating part that produces copy number information regarding a number of copies to print, wherein said print start page adding part adds said page information and the copy number information to the print data.

5. The print control device as claimed in claim 2, further comprising an equipment monitoring part that monitors a shut-off of a power of said printing device, and wherein, when a communication with said printing device is reestablished after a shut-off of the power of said printing device is detected, said page information and said copy number information is added to the print data and is resent to said printing device.

6. A printing device that performs printing based on received print data, the printing device starts printing based on page information contained in the received print data, the page information indicating a page to start the printing.

7. The printing device as claimed in claim 6, wherein printing of pages before the page to start the printing is not performed so as to start the printing from the page to start the printing.

8. The printing device as claimed in claim 6, wherein the printing is started based on copy number information contained in the received print data, the copy number information indicating a number of copies to print.

9. A network system comprising:
a print control device that controls an operation of a printing device, said print control device comprising: a bidirectional communication start command adding part that adds a bidirectional communication start command to print data; a print data storing part that stores the print data which has been sent to said printing device; and a page information receiving part that receives information indicating pages already printed, the information being sent from said printing device; and
a printing device that performs printing based on received print data, the printing device starts printing based on page information contained in the received print data, the page information indicating a page to start the printing,
wherein said print control device and said printing device are connected through a network.

10. A print control method of a printing device that performs printing based on received print data, the print control method comprising:
adding a bidirectional communication start command to the print data and sending the print data to said printing device;
sending a page completion notification from said printing device each time printing of one page is completed;
adding page information indicating a page to start printing to said print data and resending the print data to said printing device when a power of said printing device is turned on after the power of said printing device is shut off in a middle of printing; and
performing remaining printing based on the page information.

11. The print control method as claimed in claim 10, wherein the step of resending adds information indicating a number of remaining copies.

12. A print control program causing a computer to perform a print control method of a printing device that performs printing based on received print data, the print control method comprising:
adding a bidirectional communication start command to the print data and sending the print data to said printing device;
sending a page completion notification from said printing device each time printing of one page is completed;
adding page information indicating a page to start printing to said print data and resending the print data to said printing device when a power of said printing device is turned on after the power of said printing device is shut off in a middle of printing; and
performing remaining printing based on the page information.

13. A computer readable recording medium storing a print control program causing a computer to perform a print control method of a printing device that performs printing based on received print data, the print control method comprising:
adding a bidirectional communication start command to the print data and sending the print data to said printing device;
sending a page completion notification from said printing device each time printing of one page is completed;
adding page information indicating a page to start printing to said print data and resending the print data to said printing device when a power of said printing device is turned on after the power of said printing device is shut off in a middle of printing; and
performing remaining printing based on the page information.
